(19) United States
(12) Patent Application Publication
(10) Pub. No.: US 2012/0228785 A1
(43) Pub. Date: Sep. 13, 2012

(54) WATER FILTERING DEVICE EQUIPPED WITH WATER LEVEL ADJUSTMENT UNIT

(76) Inventors: Joung-Soo Park, Jeonju-si (KR); Heung-Jun Park, Gwangju (KR); Sung-Tae Joo, Gwangju (KR); Min-Ha Kim, Gwangju (KR); Dong-Houn Yang, Gwangju (KR); Jong-Kwon Lee, Gwangju (KR)

(21) Appl. No.: 13/510,848

(22) PCT Filed: Apr. 21, 2010
(86) PCT No.: PCT/KR2010/002486

§ 371 Date: May 18, 2012

(30) Foreign Application Priority Data
Nov. 19, 2009 (KR) 10-2009-0111791

(51) Int. Cl. B01D 47/02

(52) U.S. Cl. 261/38; 261/74

(57) ABSTRACT

A water filtering device equipped with a water level adjustment unit is provided. The water filtering device includes an external air inlet through which dust-containing air flows in, a dust separator communicating with the external air inlet and separating dust in the inflow air, exhaust outlets communicating with the dust separator and discharging the air from which the dust has been separated, a dust container communicating with the dust separator and being filled with water, and a water level adjustment unit installed in the dust container to adjust the level of the water in the dust container. The water level adjustment unit includes a supercharged water drainage tube installed on a bottom of the dust container, and a manual opening/closing device for adjusting the level of the water through the supercharged water drainage tube.

### CROSS-REFERENCE TO RELATED APPLICATIONS

This application is a national phase application, under 35 U.S.C. 371, of International Application No. PCT KR2010/002486, filed Apr. 21, 2010, which claimed priority to Korean application number 10-2009-0111791, filed Nov. 19, 2009, in the Korean intellectual Property Office, the disclosures of both which are incorporated herein by reference.

### BACKGROUND

1. Field

Exemplary embodiments of the following disclosure relate to a water filtering device, and more particularly to a water filtering device equipped with a water level adjustment unit for an electric cleaner.

2. Description of the Related Art

In general, an electric cleaner creates a vacuum therein using a motor fan to perform cleaning using the created vacuum, and due to its' electrical characteristics, it is normally kept away from moisture or water. On the other hand, in order to heighten dust collection efficiency, a wet vacuum cleaner using water has been widely used.

In such a wet vacuum cleaner, a dust tank, in which dust is collected, may be filled with water to a predetermined water level. In order to prevent an overflow, for example, due to a supercharged water supply, or a decrease of the dust collection efficiency, for example, due to low-level water supply, an appropriate water level (amount of water) may be set. The water supply to the dust tank is adjusted to the set water level.

An appropriate water level (amount of water) may be defined as a water level (amount of water) that is set to achieve efficient dust collection without generating overflow. The appropriate water level may be determined through experiments in which the cleaner is operated after water is supplied into the dust tank at various water levels (amounts of water), for example, in the product development process.

Korean Patent Application Publication No. 2008-0114668 discloses a construction in which a bracket having a mount groove is installed on a lower of an inlet of a water storage tank and an overflow prevention structure inserted into the mount groove. This construction may prevent the overflow by the overflow prevention structure rising due to buoyancy to close the inlet when the water storage tank is filled with water.

Korean Patent Registration No. 0113197 discloses a structure in which a water inlet for supplementing water is formed on one side of an upper portion of a water storage tank with a floater that rises/drops depending on the amount of water in the storage tank to prevent the overflow is installed in the storage tank.

However, these related arts merely disclose structures for preventing the water stored in the water tank from overflowing the water tank, but fail to disclose, for example, a structure for adjusting the water level of a water filtering device, which, for example, removes dust in dust-containing air that flows in from outside using the water.

In the water filtering device, an appropriate water level may be linked to not only the overflow but also the dust collection efficiency, and thus it is important for a user to constantly keep the water level while operating the water filtering device. Accordingly, a water filtering device whereby a user can conveniently keep the appropriate water level thereof is desired.

### SUMMARY

Exemplary embodiments of the present disclosure address at least the above problems and/or disadvantages and provide at least the advantages described below. Accordingly, an aspect of the present invention provides a water filtering device equipped with a water level adjustment unit that can appropriately adjust the level of water therein.

According to an aspect of the present invention, a water filtering device equipped with a water level adjustment unit includes an external air inlet through which dust-containing air flows in, a dust separator communicating with the external air inlet and separating dust in the inflow air, exhaust outlets communicating with the dust separator and discharging the air from which the dust has been separated, a dust container communicating with the dust separator and being filled with water, and a water level adjustment unit installed in the dust container to adjust the level of the water in the dust container, wherein the water level adjustment unit includes a supercharged water drainage tube installed on a bottom of the dust container, and a manual opening/closing means for selectively adjusting the level of the water through the supercharged water drainage tube. Accordingly, a user can keep an appropriate level of the water in the dust container of the water filtering device that separates the dust in the air.

According to an exemplary embodiment of the present invention, the manual opening/closing means includes an opening/closing valve opening and closing the supercharged water drainage tube, a valve holder plate supporting the opening/closing valve, and a sealing piece provided on the opening/closing valve.

An end of the opening/closing valve may be configured to be elastically supported.

An end of the supercharged water drainage tube may be configured to be inclined.

The manual opening/closing means may be configured to be installed on an outer surface of the bottom of the dust container.

The water level adjustment unit may further include a sealing member separating an inner space of the dust container into a peripheral area in which the supercharged water drainage tube is installed and other areas.

According to an exemplary embodiment of the present invention, a soft sealing ring is attached to a lower end of the sealing member.

The supercharged water drainage tube may be a tube which is penetrated on both ends and is provided with an end that projects from the bottom surface of the inner side of the dust container with an appropriate height and the other end that communicates with an outer side of the dust container to drain the water to outside.

The water level adjustment unit may include, instead of the manual opening/closing means, a floater mounted on an end of the supercharged water drainage tube to open and close the supercharged water drainage tube depending on the water level.

The floater may be configured to further include an arm that is inserted into an upper end opening of the supercharged water drainage tube.

The water level adjustment unit may further include a sealing member separating an inner space of the dust container into a peripheral area in which the supercharged water drainage tube is installed and other areas.

A soft sealing ring may be attached to a lower end of the sealing member.

According to an exemplary embodiment of the present invention, since the level of the water contained in the water filtering device can be easily adjusted to an appropriate level, high dust collection efficiency can be achieved.

The overflow of water can be prevented while the cleaner operates or is moved.

Since the peripheral area in which the supercharged water drainage tube is installed is separated by the sealing member, the supercharged water drainage tube and water distribution ports are prevented from being polluted and clogged while the cleaner operates or is moved.

Further, since the dust collection areas communicate with each other so that water flows between the collection areas, the balance of water level between the collection areas is prevented from being broken.

### BRIEF DESCRIPTION OF THE DRAWINGS

These and/or other aspects and advantages will become apparent from the following description of embodiments, taken in conjunction with the accompanying drawings, of which:

FIG. 1 illustrates a water filtering device according to an exemplary embodiment of the present invention;

FIG. 2 illustrates a water filtering device according to an embodiment of the present invention;

FIG. 3 is a cross-sectional view taken along line V-V′ of FIG. 1;

FIG. 4 illustrates a dust container;

FIG. 5 illustrates a dust container of a water filtering device according to an exemplary embodiment of the present invention;

FIG. 6 illustrates an exemplary operation of a manual water level adjustment unit applied to a dust container of a water filtering device according to an exemplary embodiment of the present invention;

FIG. 7 illustrates an exemplary operation of an automatic water level adjustment unit applied to a dust container of a water filtering device according to an exemplary embodiment of the present invention; and

FIG. 8 illustrates a drainage tube unit of a water filtering device according to an embodiment of the present invention.

### DETAILED DESCRIPTION

Reference will now be made in detail to the embodiments, examples of which are illustrated in the accompanying drawings, wherein like reference numbers for like elements throughout. The embodiments are described below to explain the present disclosure by referring to the figures.

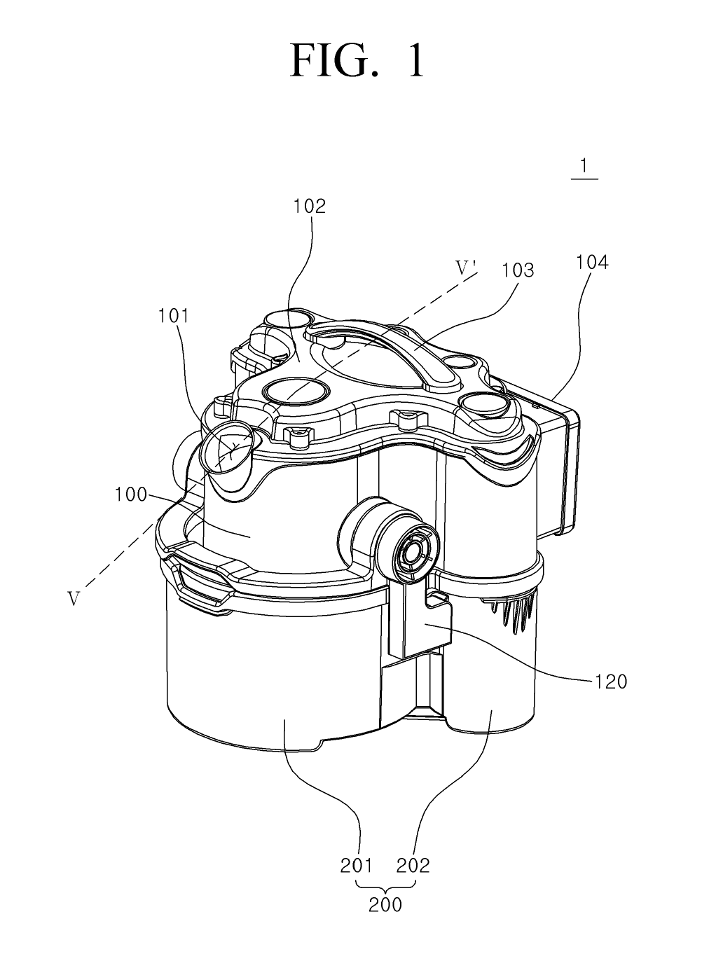

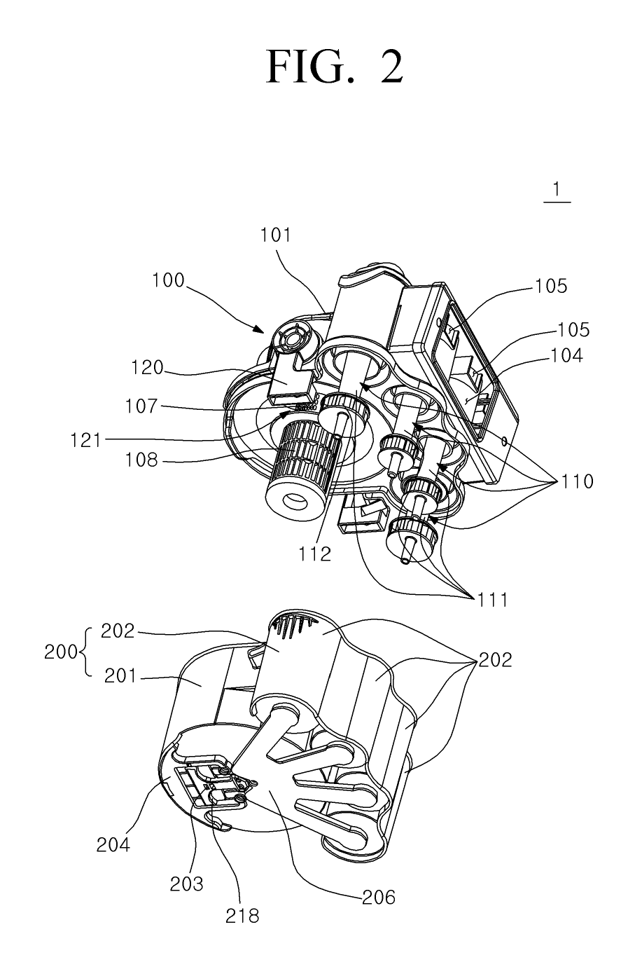

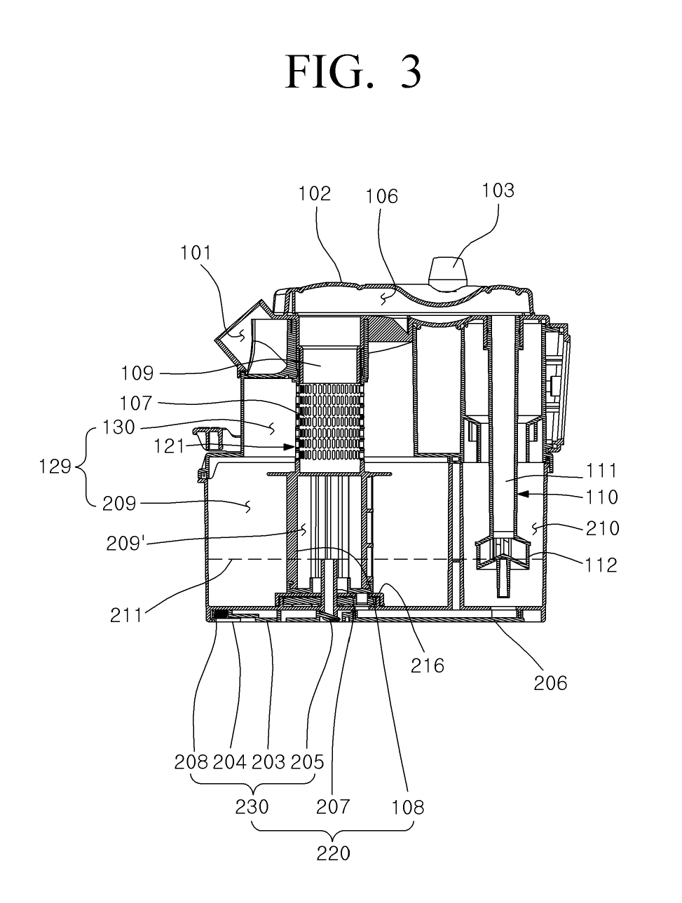

FIG. 1 illustrates a water filtering device 1 equipped with a water level adjustment unit 220 (see FIG. 3) according to an exemplary embodiment of the present invention. FIG. 2 illustrates the water filtering device, and FIG. 3 is a cross-sectional view taken along line V-V′ of FIG. 1. The drawing reference numeral 200 denotes a dust container in which supplied water is stored and collected dust is accumulated.

Referring to FIGS. 1 to 3, a water filtering device 1 according to an exemplary embodiment of the present invention includes a dust container 200 and a body 100 that generates a rotating air flow to separate dust from dusty air that contains dust. The body 100 has airflow paths formed thereon, and serves as a cover of the dust container 200.

Referring to FIGS. 2 and 3, the body 100 includes a rotating airflow generator 101, an exhaust tube unit 121, a first exhaust chamber 106, and a plurality, e.g., four inlet tube units 110.

The rotating airflow generator 130 may be a part of the dust separator 129, and may be formed on an upper side of a first dust collection area 209 to change dust-containing airflow flowing through an external air inlet 101 to a downward rotating airflow. The dust separator 129 includes the rotating airflow generator 130 and the first dust collection area 209.

The exhaust tube unit 121 is an exemplary path through which first purified air, from which dust is primarily filtered through the dust separator 129 and the first dust collection area 209, flows to the first exhaust chamber 106, and a grill portion 107 having a plurality of holes formed thereon to filter large-size dust and an exhaust tube 109 may be integrally connected to each other.

The exhaust chamber 106 communicates with the exhaust tube unit 121 to collect the purified air, and may be blocked from outside by an exhaust chamber cover 102.

The inlet tube units 110 communicate with the exhaust chamber 106 to send the purified air to a dust collection area 210.

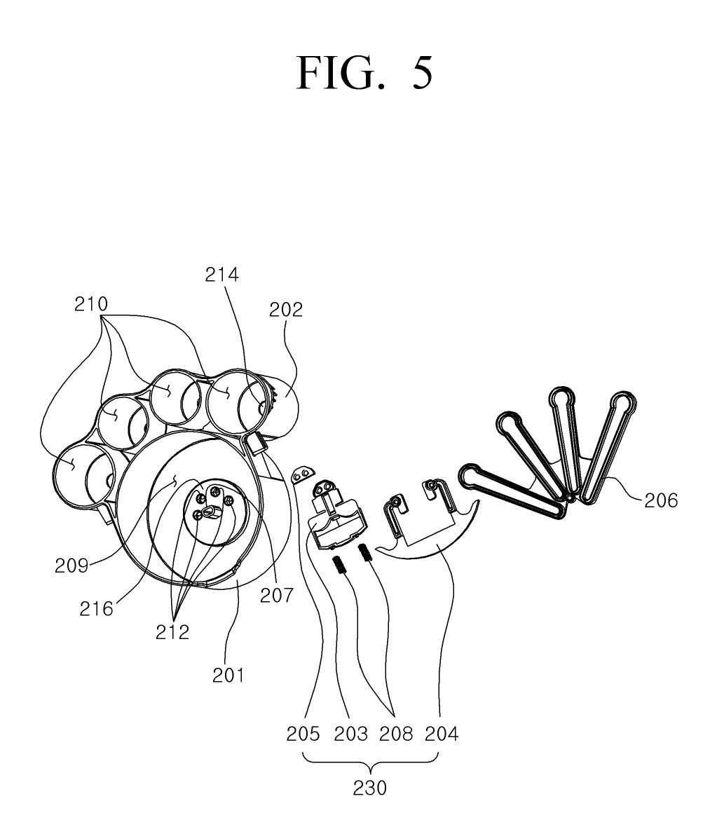

The dust container 200 may be partitioned into a first dust collection area 209 and a plurality of second dust collection areas 210, for example, four second dust collection areas (see, for example, FIG. 5), and include a first dust container 201 and a plurality of second dust containers 202.

The first dust container 201 may accommodate the exhaust tube unit 121, and the plurality of second dust containers 202 may accommodate the inlet tube units 110, respectively, to form the dust collection areas 209 and 210.

An exemplary operation of a water filtering device 1 as configured above according to an exemplary embodiment of the present invention will be described with reference to FIG. 3.

If the vacuum cleaner is operated, dust-containing air having flowed through a cleaning nozzle potion (not illustrated) flows into the water filtering device 1 through the external air inlet 101 that is formed to be inclined on an upper corner of the body 100.

The inflow dust-containing air passes through the rotating airflow generator 130 to form a downward rotating airflow. This downward rotating airflow is decelerated while passing through the first dust collection area 209 of the first dust container 201 that is filled with water at an appropriate water level, and the dust is primarily collected in a manner that a part of the dust falls due to gravity and another part of the dust becomes in contact with water.

The first purified airflow primarily processed may be collected in the exhaust chamber 106 through the grill 107 and the exhaust tube 109.

The exhaust chamber 106 communicates with respective inlet tubes 111 of inlet tube units 110, and at a lower end of each inlet tube 111, a rotating airflow generation nozzle 112 may be installed to generate a downward rotating airflow.

Accordingly, a downward rotating airflow is generated in a second dust collection area 210 of the second dust container 202 that is filled with water at an appropriate level 211, and a secondary dust collection is performed while the first purified airflow collides with the stored water and rises. The secondarily dust-collected purified air is discharged to outside through second exhaust outlets 105 and a purified air chamber 104.

In the vacuum cleaner adopting the water filtering device 1, water is supplied to the dust container 200 before operating the cleaner, and the polluted water is drained after using the cleaner. Further, during the water supply, the water is kept at an appropriate level 211 to prevent the overflow of the supplied water and to achieve high dust collection efficiency while the cleaner is operated.

An appropriate water level 211 may be defined as a water level 211 that is set for efficient dust collection through experiments in which the cleaner is operated after water is supplied into the dust container 200 at various water levels 211, for example, in the product development process. The values may be empirically determined.

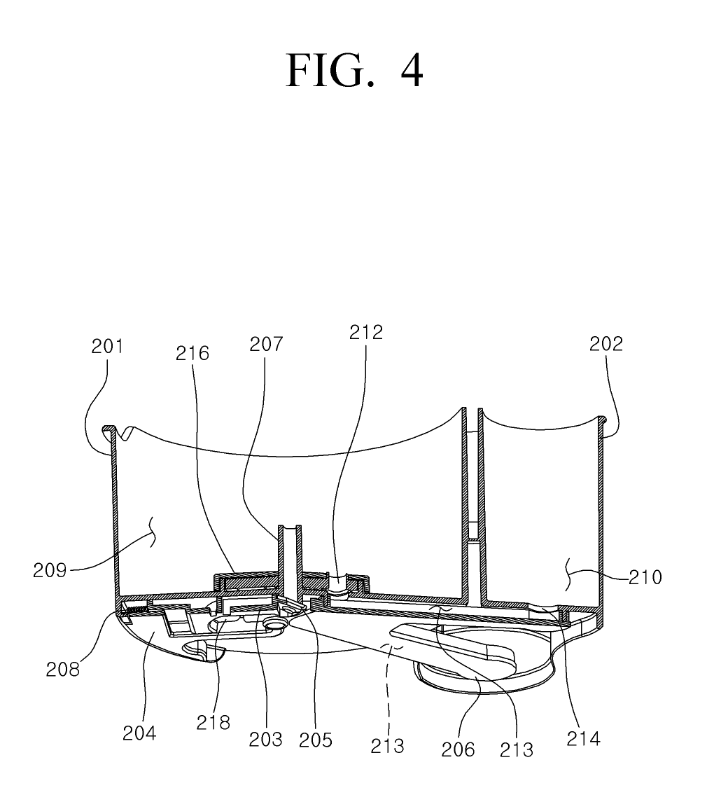

The dust container 200 of the water filtering device 1 and the water supply thereto according to an exemplary embodiment of the present invention are discussed in detail with reference to FIGS. 4 and 5.

FIG. 4 illustrates part of dust container 200 illustrated in FIG. 3, and FIG. 5 is an exploded perspective view illustrating a dust container 200 of a water filtering device 1 according to an exemplary embodiment of the present invention.

The dust container 200 that serves as a low-level water tank includes a first dust container 201 and a plurality (e.g., four) second dust containers 202 connected to the first dust container 201 through a plurality (e.g., four) water paths 213.

The water paths 213 may be formed by water distribution path members 206 installed on the lower side of the dust container 200, and may be independently connected to the second dust containers 202 around the first dust container 201.

That is, the water that is supplied to the first dust container 201 may be supplied to the second dust containers 202 through the water paths, and the water that is supplied to the second dust containers 202 may be supplied to the first dust container 201 through the water paths 213. However, direct water supply and drainage is not necessarily performed between the respective second dust containers 202.

On the center portion of an inner side of the first dust container 201, the supercharged water drainage tube 207 for discharging the water that is supplied over the appropriate water level 211 may be formed to project as high as the appropriate water level 211. The lower side of the supercharged water drainage tube 207 may communicate with the outside to drain the supercharged water that exceeds the water level corresponding to the upper end portion of the supercharged water drainage tube 207.

On portions that are separated from the supercharged water drainage tube 207 in the directions of the respective second dust containers, water distribution ports 212 that are connected to the water paths 213 may be formed. Further, on the center portions of inner sides of the second dust containers 202, water supply ports 214 may be formed to be connected to the respective water paths 213 so as to perform water supply and drainage.

Accordingly, the water supplied through the water distribution ports 212 and the water supply paths 213 of the first dust container 201 and the water supply ports 214 of the second dust containers 202 is distributed to keep the same water level.

To supply water to the dust container 200, the body 100 may be separated in a manner that a locking knob 120 is rotated to be released from the body 100, and the body 100 may be lifted up using a handle 103 provided, for example, at an upper end of the body 100 (see FIG. 1). Thereafter, water supply may be performed through an open upper portion of the dust container 100. The water supply may be performed in a manner that the first dust container 201 is filled with water and the filled water is supplied to the second dust containers 202 through the water paths 213.

As the water level becomes higher through the water supply to the first dust container 201, the water is supplied to the four second dust containers 202 through the four water distribution ports 212 formed on the lower side of the first dust container 201 and the water paths 213 connected to the water distribution ports 212. If the water supply is finished, the water levels of the first dust container 201 and the second containers 202, which communicate with each other, become equal to each other.

As described above, the water level of the dust container portion 200 exerts an influence on the dust collection efficiency of the water filtering device 1. In order to prevent an overflow due to the supercharged water supply or the decrease of the dust collection efficiency due to the low-level water supply, the water level may be adjusted to the appropriate water level 211.

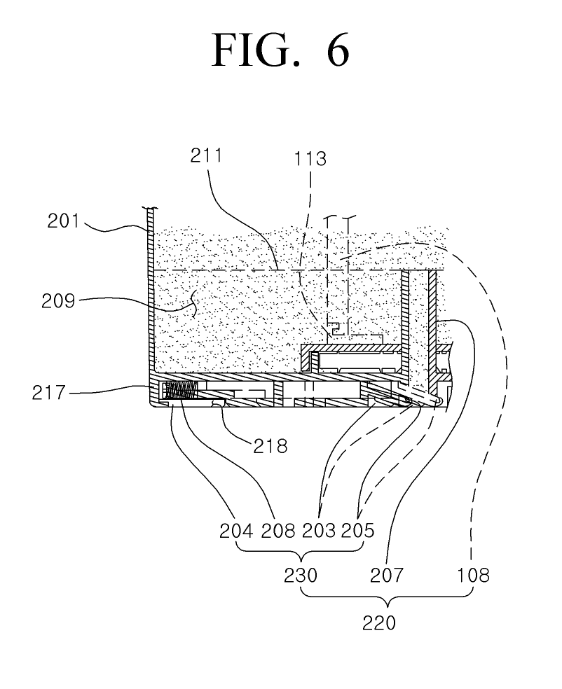

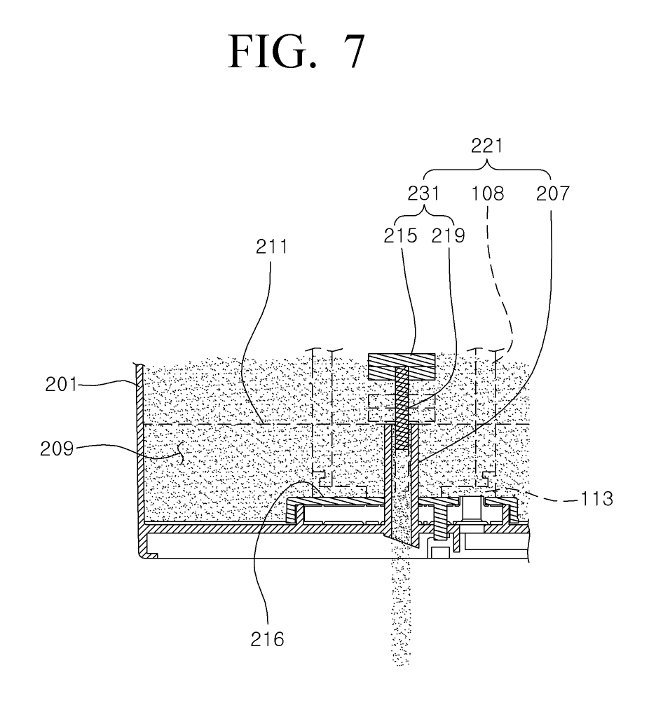

A structure to set the water level of the dust container 200 to the appropriate level will be described in detail with reference to FIGS. 5 to 7. FIG. 5 is an exploded perspective view illustrating a dust container 200 of a water filtering device 1 according to an exemplary embodiment of the present invention. FIG. 6 is a cross-sectional view of a part showing the operation of a manual water level adjustment unit 220 applied to a dust container 200 of a water filtering device 1 according to an exemplary embodiment of the present invention, and FIG. 7 is a cross-sectional view of a main part showing the operation of an automatic water level adjustment unit 221 applied to a dust container 200 of a water filtering device 1 according to another embodiment of the present invention. FIG. 7 illustrates an open state of an opening/closing valve 203 and a floater 215 to drain the supercharged water. The water level adjustment unit may be the manual water level adjustment unit 220 or the automatic water level adjustment unit 221.

In FIG. 6, the manual water level adjustment unit 220 includes a supercharged water drainage tube 207, a manual opening/closing part 230, and a sealing member 108.

The supercharged water drainage tube 207 may be a tube is penetrated on both ends, and has one end that projects from the bottom surface of the inner side of the first dust container 201 with a height corresponding to the appropriate water level 211 and an other end that communicates with an outer side of the first dust container 201 to drain the water to the outside.

The manual opening/closing part 230 includes an opening/closing valve 203, a valve holder plate 204, a sealing piece 205, and a compression spring 208.

The left end of the opening/closing valve 203 may be elastically supported by the compression spring 208 to be in a slightly compressed state against a rib 217 formed on the lower side of the first dust container 201, and a force may be constantly applied toward the lower end opening of the supercharged water drainage tube 207.

At the lower end of the opening/closing valve 203, a finger groove 218 may be formed to enable a user to open the opening/closing valve 203 using a finger, and the opening/closing valve is slidably supported by the valve holder plate 204 that is mounted to be elastically supported by the compression spring 208. A surface of the opening/closing valve 203 may be in contact with the inclined end of the supercharged water drainage tube 207 at the same inclination angle.

As indicated by a solid line, in order to drain the supercharged water, the supercharged water in the dust container portion 200 is drained until the water level reaches the appropriate level 211 in a state where the opening/closing valve 203 is pushed to the left to be opened as seen from the drawing. Further, as indicated by a dotted line, the sealing piece 205 attached to the right end of the opening/closing valve 203 closes up the lower end of the supercharged water drainage tube 207 to prevent the drainage of the water during the operation or movement of the cleaner.

Accordingly, if the user puts his/her finger onto the finger groove 218 and opens the opening/closing valve 203 through pushing of the opening/closing valve 203 to the left, the supercharged water in the dust container portion 200 is discharged to the outside. If the user takes off his/her finger from the finger groove 218 after confirming that the water is not drained any more through the supercharged water drainage tube 207, the opening/closing valve 203 is operated by a restoration force of the compression spring 208 and the sealing piece 205 attached to the opening/closing valve 203 closes up the lower end opening of the supercharged water drainage tube 207 to prevent the water from flowing out even in the case where the water in the dust container portion 200 is shaken.

The structure and operation of the sealing member 108 as indicated by a dotted line is disclosed.

FIG. 7 illustrates an automatic water level adjustment unit 221 including a supercharged water drainage tube 207, an automatic opening/closing means 231, and a sealing member 108.

Since the supercharged water drainage tube 207 is similar to that according to the above-described embodiment, the detailed description thereof will be omitted.

The automatic opening/closing device 231 may be a floater 215 that is mounted on an upper side of the supercharged water drainage tube 207 to move upward and downward depending on the water level. An arm portion 219 may be engaged with the lower portion of the floater 215 and inserted into the supercharged water drainage tube 207 and the floater 215 moves upward and downward depending on the water level to open or close the supercharged water drainage tube 207.

If the water level is higher than the appropriate water level 211, the floater 215 floats on the water and the supercharged water drainage tube 207 is opened to drain the water. If the water level approaches the appropriate water level 211 through the drainage, the floater 215 gradually closes up the supercharged water drainage tube 207 to stop the drainage.

Accordingly, the floater 215 may be made of a material having a greater specific gravity than water, such as a foam material.

However, since the floater 215 may serve as a valve that closes up the supercharged water drainage tube 207, the floater 215 may be used in combination with a flexible material that is relatively heavy suitable for sealing, such as rubber.

The sealing member 108 sealing the water distribution ports 212 distributing water between the first dust container 201 and the second dust containers 202 and the supercharged water drainage tube 207 are described.

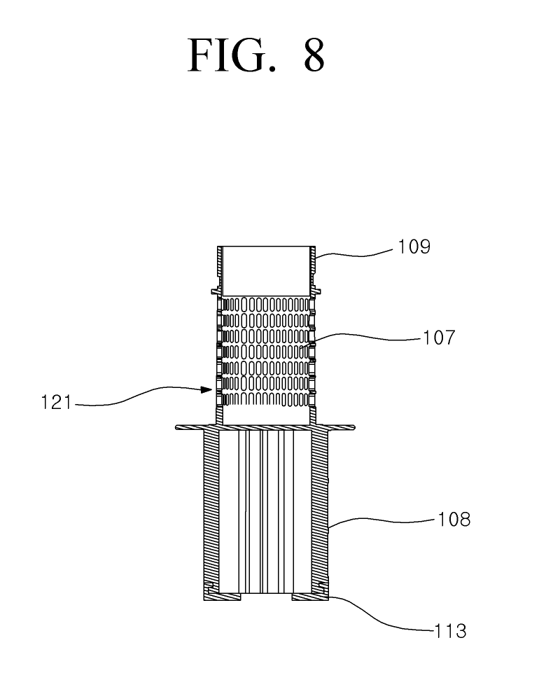

FIG. 8 illustrates a drainage tube unit 121 of a water filtering device 1 according to an exemplary embodiment of the present invention. The sealing member 108 may be integrally formed on the lower side of the grill portion 107 in the form of a cup turned upside down.

If the body portion 100 is engaged after the water level of the dust container portion 200 is appropriately adjusted, the sealing member 108 blocks the supercharged water drainage tube 207 and the water distribution ports 212 from the first dust collection area 209 as illustrated, for example, in FIG. 3. That is, the sealing member 108 separates the inner space of the dust container portion 200 into a peripheral area 209′ in which the supercharged water drainage tube 207 is installed and other areas.

This prevents the supercharged water drainage tube 207 and the water distribution ports 212 from being polluted and clogged while the cleaner operates or is moved, and prevents the balance of the water levels between the first collection area and the second collection areas, which communicate with each other so that the water flows between them, from being broken.

For improved blocking, a soft sealing ring 113 such as rubber may be inserted into the lower end portion of the sealing member 108 to achieve an effective sealing with a corresponding sealing surface 216 of the first dust container 201.

That is, the sealing ring 113 may be seated on the sealing surface 216 to achieve the sealing and to close up the water distribution ports 213 formed on the sealing surface 216, and thus the connection between the first dust container 201 and the second dust containers 202 is intercepted so as not to influence the water levels therein during the operation or movement of the cleaner.

The water filtering device equipped with drainage members according to an exemplary embodiment of the present invention can be applied to varied electronic appliances, and representatively, to vacuum cleaners for home use, for industrial use, and for commercial use.

Although a few embodiments have been shown and described, it would be appreciated by those skilled in the art that changes may be made in these embodiments without departing from the principles and spirit of the invention, the scope of which is defined in the claims and their equivalents.

1. A water filtering device equipped with a water level adjustment unit, comprising:
an external air inlet through which dust-containing air flows in;
a dust separator communicating with the external air inlet and separating dust in the inflow air;
exhaust outlets communicating with the dust separator and discharging the air from which the dust has been separated;
a dust container communicating with the dust separator and being filled with water; and
a water level adjustment unit installed in the dust container to adjust the level of the water in the dust container portion,
wherein the water level adjustment unit includes:
a supercharged water drainage tube installed on a bottom of the dust container portion, and
a manual opening/closing device for adjusting the level of the water through the supercharged water drainage tube.

2. The water filtering device as claimed in claim 1, wherein the manual opening/closing device comprises:
an opening/closing valve opening and closing the supercharged water drainage tube,
a valve holder plate supporting the opening/closing valve, and
a sealing piece provided on the opening/closing valve.

3. The water filtering device as claimed in claim 2, wherein an end of the opening/closing valve is elastically supported.

4. The water filtering device as claimed in claim 1, wherein an end of the supercharged water drainage tube is inclined.

5. The water filtering device as claimed in claim 1, wherein the manual opening/closing device is installed on an outer surface of the bottom of the dust container portion.

6. The water filtering device as claimed in claim 1, wherein the water level adjustment unit further comprises a sealing member separating an inner space of the dust container portion into a peripheral area in which the supercharged water drainage tube is installed and other areas.

7. The water filtering device as claimed in claim 6, wherein a soft sealing ring is attached to a lower end of the sealing member.

8. The water filtering device as claimed in claim 1, wherein the supercharged water drainage tube is a tube which is penetrated on both ends, and is provided with an end projecting from the bottom surface of the inner side of the dust container portion with an appropriate height and the other end communicating with an outer side of the dust container portion to drain the water to outside.

9. A water filtering device equipped with a water level adjustment unit, comprising:
an external air inlet through which dust-containing air flows in;
a dust separator communicating with the external air inlet and separating dust in the inflow air;
exhaust outlets communicating with the dust separator and discharging the air from which the dust has been separated;
a dust container portion communicating with the dust separator and being filled with water; and
a water level adjustment unit installed in the dust container portion to adjust the level of the water in the dust container portion,
wherein the water level adjustment unit includes:
a supercharged water drainage tube formed to project from a bottom surface of the dust container portion, and
a floater mounted on an end of the supercharged water drainage tube to open and close the supercharged water drainage tube depending on the water level.

10. The water filtering device as claimed in claim 9, wherein the floater further comprises an arm portion that is inserted into an upper end opening of the supercharged water drainage tube.

11. The water filtering device as claimed in claim 9, wherein the water level adjustment unit further comprises a sealing member separating an inner space of the dust container portion into a peripheral area in which the supercharged water drainage tube is installed and other areas.

12. The water filtering device as claimed in claim 11, wherein a soft sealing ring is attached to a lower end of the sealing member.

13. A filtering device, comprising:
an inlet through which particle-containing gas flows in;
a particle separator communicating with the inlet and separating particles that were contained in the particle-containing gas;
exhaust outlets communicating with the particle separator and discharging the gas from which the particles have been separated;
a particle container communicating with the particle separator and being filled with a liquid; and
a liquid level adjustment unit to adjust the level of the liquid in the particle container.

14. The filtering device according to claim 13, further comprising a liquid drainage tube installed on a bottom of the particle dust container.

15. The filtering device according to claim 14, further comprising a opening/closing device for adjusting the level of the liquid through the liquid drainage tube.

16. The filtering device according to claim 15, wherein the opening/closing device is a manual opening/closing device.
